(19) United States
(12) Patent Application Publication
(10) Pub. No.: US 2011/0243177 A1
(43) Pub. Date: Oct. 6, 2011

(54) GAS LASER DEVICE

(75) Inventors: Akihiko Nishio, Minamitsuru-gun (JP); Takafumi MURAKAMI, Minamitsuru-gun (JP)

(73) Assignee: FANUC CORPORATION, Minamitsuru-gun (JP)

(21) Appl. No.: 13/038,568

(22) Filed: Mar. 2, 2011

(30) Foreign Application Priority Data
Apr. 2, 2010 (JP) 2010-086076
Nov. 9, 2010 (JP) 2010-250930

(51) Int. Cl. H01S 3/22

(52) U.S. Cl. 372/58

(57) ABSTRACT

A gas laser device including a blower circulating a laser gas along a gas passage; a pressure detection section detecting a gas pressure of the laser gas in the gas passage; a gas supply and exhaust section supplying the laser gas to the gas passage and exhausting the laser gas from the gas passage; an instruction section instructing a temporary stop of a laser oscillation by a laser oscillator; and a control section controlling the blower and the gas supply and exhaust section in response to an instruction from the instruction section. The control section, before the instruction section instructs the temporary stop, controls the blower to rotate at a predetermined rotation number and controls the gas supply and exhaust section so that the gas pressure detected by the pressure detection section is a first target gas pressure and, once the instruction section instructs the temporary stop, controls the blower so as to reduce the rotation number of the blower or stop the rotation of the blower and controls the gas supply and exhaust section so that the gas pressure detected by the pressure detection section is a second target gas pressure corresponding to the first target gas pressure during the rotation of the blower.

### BACKGROUND OF THE INVENTION

1. Field of the Invention

The present invention relates to a gas laser device that uses a gas as an excitation medium.

2. Description of the Related Art

There is known a gas laser device in which a laser gas vessel is filled with a laser gas as an excitation medium, which is circulated by a blower, and the laser gas is excited by being discharged from discharge electrodes to output laser light. In the device described in Japanese Unexamined Patent Publication (kokai) No. H11-112064 (JP11-112064A), when the device is in a laser ON state in which the laser light is output, the blower is rotated and, when the device is not in the laser ON state, the blower is temporarily stopped.

However, if the blower is temporarily stopped when the device is not in the laser ON state as the device described in JP11-112064A, gas pressure in the laser gas vessel may be changed due to leakage of the vessel and the like. Then, if the temporary stop is cancelled and the blower is restarted in this state before laser oscillation, the laser gas has to be supplied to the vessel or exhausted from the vessel to adjust the gas pressure in the vessel to a predetermined pressure. Consequently, it takes time to return to the state in which the laser oscillation is possible and, as a result, working efficiency of laser processing and the like may be degraded.

### SUMMARY OF THE INVENTION

According to an aspect of the present invention, a gas laser device includes a passage formation section forming a gas passage through which a laser gas circulates; a blower circulating the laser gas along the gas passage; a laser oscillator oscillating laser light by using the laser gas flowing through the gas passage as an excitation medium; a laser power supply supplying electric power for exciting the laser gas to the laser oscillator; a pressure detection section detecting a gas pressure of the laser gas in the gas passage which changes depending on a rotation number of the blower; a gas supply and exhaust section supplying the laser gas to the gas passage and exhausting the laser gas from the gas passage; an instruction section instructing a temporary stop of oscillation of the laser light by the laser oscillator; and a control section controlling the blower and the gas supply and exhaust section in response to an instruction from the instruction section, wherein, before the instruction section instructs the temporary stop, the control section controls the blower so as to rotate at a predetermined rotation number, and controls the gas supply and exhaust section so that the gas pressure detected by the pressure detection section is a first target gas pressure and, once the instruction section instructs the temporary stop, the control section controls the blower so as to reduce the rotation number of the blower or stop the rotation of the blower, and controls the gas supply and exhaust section so that the gas pressure detected by the pressure detection section is a second target gas pressure corresponding to the first target gas pressure during the rotation of the blower.

### BRIEF DESCRIPTION OF THE DRAWINGS

The object, features and advantages of the present invention will become more apparent from the following description of embodiments taken in conjunction with the accompanying drawings, in which:

FIG. 1 is a diagram schematically illustrating a configuration of a gas laser device according to an embodiment of the present invention;

FIG. 2 is a block diagram illustrating a controlling configuration of a gas laser device according to an embodiment of the present invention;

FIG. 3 is a flowchart illustrating an example of a temporary stop process carried out in a control section of FIG. 2;

FIG. 4A is a diagram illustrating an example of operation of a gas laser device according to an embodiment of the present invention;

FIG. 4B is a diagram illustrating an example of operation of a gas laser device according to an embodiment of the present invention;

FIG. 5 is a diagram schematically illustrating a gas state of the gas laser device;

FIG. 6A is a diagram illustrating a comparative example of FIG. 4A; and

FIG. 6B is a diagram illustrating a comparative example of FIG. 4B.

### DETAILED DESCRIPTION

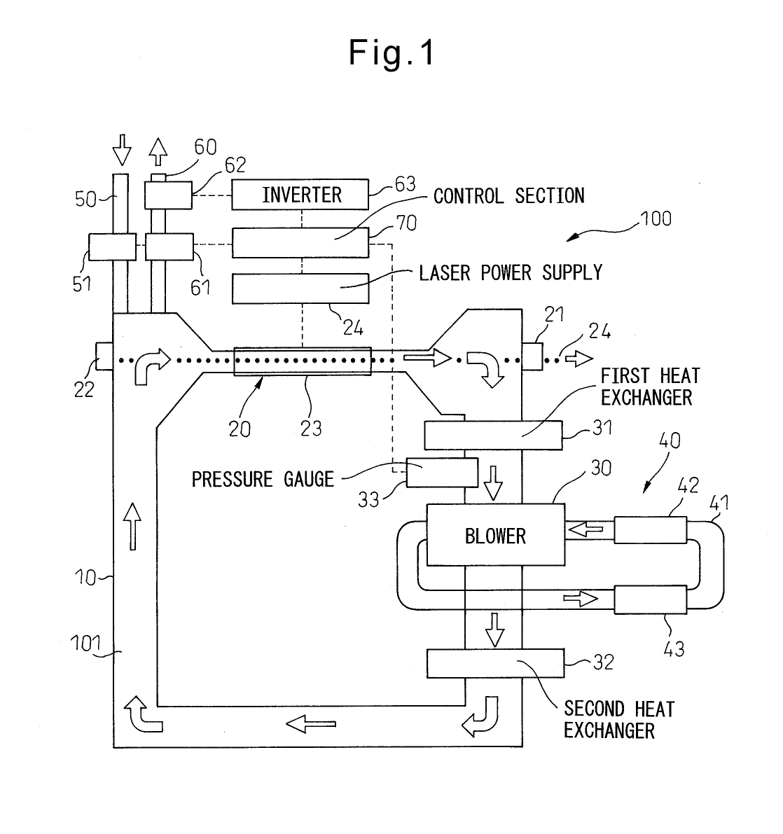

Hereinafter, referring to FIGS. 1 to 6B, embodiments of the present invention will be described. FIG. 1 is a diagram schematically illustrating a configuration of a gas laser device 100 according to an embodiment of the present invention. This gas laser device 100 comprises a laser gas vessel 10 forming a gas passage 101 through which a laser gas circulates, and a laser oscillator 20 and a blower 30 disposed on gas passage 101. Gas laser device 100 according to this embodiment can be used in many fields such as manufacturing, medical care and measurement.

Laser gas vessel 10 accommodates a predetermined laser gas isolated from the atmosphere. As the laser gas, a gas medium for laser oscillation including laser media, such as carbon dioxide, nitrogen gas and argon gas, is used.

Laser oscillator 20 has an output mirror 21, a rear mirror 22, and a discharge tube 23 disposed between output mirror 21 and rear mirror 22. Discharge tube 23 communicates with gas passage 101. A laser power supply 24 supplies electric power to discharge tube 23. When laser power supply 24 supplies the electric power, the laser gas is excited during passing through discharge tube 23 and brought into a laser-active state. Light arising from discharge tube 23 is amplified between output mirror 21 and rear mirror 22, and laser-oscillated to generate laser light. Since output mirror 21 is a semitransparent mirror, the laser light passing through output mirror 21 is output to the outside as output laser light 24.

Blower 30 is comprised of a fan or blower driven by an electric motor. In other words, blower 30 of this specification also contains the fan of which a compression ration is smaller than that of the blower. Blower 30 is supplied with electric power via an unillustrated blower inverter, and rotated by this electric power to circulate the laser gas along gas passage 101. A first heat exchanger 31 and a second heat exchanger 32 are disposed on gas passages 101 of the upstream and downstream sides of blower 30, respectively. Heat exchangers 31 and 32 are supplied with a predetermined coolant (for example, cooling water). The laser gas is cooled during passing through heat exchangers 31 and 32 due to heat exchange with this coolant, and maintained at a predetermined temperature.

In order to suppress heating of blower 30, gas passage 101 is provided with a cooling device 40. Cooling device 40 has a coolant circulation device 42 for circulating the coolant in a coolant passage 41 and a coolant cooling device 43 for cooling the coolant. The coolant flows through a heating section of blower 30 so that blower 30 is cooled. As the coolant flowing through cooling passage 41, for example, cooling water can be used. Coolant circulation device 42 can be comprised of a pump for conveying under pressure the coolant. For example, coolant cooling device 43 can be comprised of a heat exchanger for cooling the coolant by heat exchange with the atmosphere.

Gas passage 101 communicates with a supply passage 50 for supplying the laser gas to gas passage 101 and an exhaust passage 60 for exhausting the laser gas from gas passage 101. Supply passage 50 is provided with a supply device 51 and the upstream of supply device 51 is connected to a tank (not illustrated) in which the laser gas is reserved. The pressure in the tank is higher than in gas passage 101. Supply device 51 can be comprised of a valve device which can be opened and closed, so that the laser gas is supplied from the tank to gas passage 101 via supply device 51 in response to opening and closing movement of this valve device. This valve device may not be comprised of the simple on-off valve but it may be comprised of a variable valve changing an aperture area of supply passage 50.

In exhaust passage 60, an exhaust valve 61 and an exhaust device 62 are provided in series. Exhaust valve 61 is comprised of a valve device which can be opened and closed or, for example, a variable valve changing an aperture area of exhaust passage 60. Exhaust device 62 is comprised of an exhaust fan for absorbing the laser gas from lower-pressure gas passage 101. The exhaust fan is rotated by electric power supplied via an exhaust inverter 63, so that the laser gas is exhausted from gas passage 101 according to a rotation number of exhaust device 62 (exhaust fan) and an aperture of exhaust valve 61.

A pressure (gas pressure) in laser gas vessel 10 during the laser output is, for example, set to 1/40 to ⅕ of atmospheric pressure. Though laser gas vessel 10 is hermetically sealed, it is difficult to perfectly prevent leakage and a trace amount of atmosphere penetrates into laser gas vessel 10. In addition to this, during the laser oscillation, decomposition of the laser gas and release of molecules from inner walls of the laser gas vessel occur and these may degrade the quality of the laser gas in laser gas vessel 10. In view of these problems, in this embodiment, during the laser oscillation, the laser gas is always supplied to gas passage 101 via supply passage 50 and exhausted from gas passage 101 via exhaust passage 60, so that a trace amount of the laser gas is exchanged in laser gas vessel 10 to prevent degradation of the laser gas.

The gas pressure P in laser gas vessel 10 is detected typically by a pressure gauge 33. Pressure gauge 33 is provided on the downstream side of first heat exchanger 31 and the upstream side of blower 30. Consequently, the gas pressure P detected by pressure gauge 33 varies according to the number of rotations of blower 30. More specifically, the gas pressure P decreases when blower 30 is rotated, and the gas pressure P increases when blower 30 is stopped.

At this time, assuming that a total gas weight in vessel 10 is constant, there is a certain correlation between the rotation number of blower 30 and the gas pressure P detected by pressure gauge 33. Assuming that the gas pressure is P1 at a predetermined rotation number N1 of blower 30, the gas pressure is P2 (>P1) when blower 30 stops the rotation (the rotation number is zero). This relationship can be determined in advance by experimentation or analysis. In order to distinguish this gas pressure from the gas pressure on the downstream side of blower 30 (between blower 30 and second heat exchanger 32), the gas pressure on the upstream side of blower 30 may be referred to as Pa, and the gas pressure on the downstream side of the blower 30 may be referred to as Pb.

Laser performance such as an output of a laser beam output from laser oscillator 20, a shape of the laser beam, a quality of the laser beam and the like significantly depends on the gas pressure P in laser gas vessel 10. In gas laser device 100 according to this embodiment, as a gas pressure for obtaining a desired laser performance, the gas pressure P1 corresponding to the predetermined rotation number N1 of blower 30 is predetermined. During the laser oscillation, blower 30 is allowed to rotate at the predetermined rotation number N1 and the supply and exhaust of the laser gas is controlled so that the gas pressure P detected by pressure gauge 33 is the predetermined gas pressure P1. As a result, stable laser performance can be obtained.

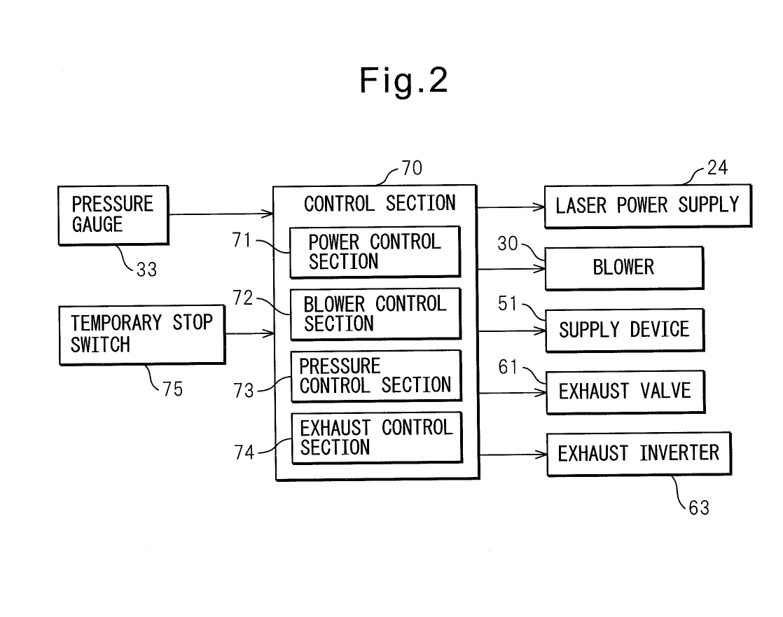

Laser power supply 24, blower 30 (blower inverter), supply device 51, exhaust valve 61 and exhaust inverter 61 are controlled by signals from control section 70. FIG. 2 is a block diagram illustrating a portion of controlling configuration of gas laser device 100 according to this embodiment. Control section 70 includes an arithmetic processing unit having a CPU, a ROM, a RAM and other peripheral circuits. Control section 70 has a power control section 71 for controlling power supply from laser power supply 24, a blower control section 72 for controlling the rotation of blower 30, a pressure control section 73 for controlling the opening and closing of supply device 51 and exhaust valve 61 and an exhaust control section 74 for controlling the rotation of exhaust device 62.

Signals from pressure gauge 33 and a temporary stop switch 75 instructing to temporarily stop the laser oscillation by laser oscillator 20 are input to control section 70 and, based on these input signals, control section 70 carries out the following process. For example, in the case of the laser processing of a workpiece by gas laser device 100, the temporary stop is instructed when the laser output is temporarily unnecessary for example, such as during the workpiece exchange, and it is different from the complete stop instructed after the termination of the laser process. In a memory of control section 70, a predetermined rotation number N1 of blower 30, the predetermined gas pressure P1 during the rotation of the blower and the predetermined gas pressure P2 during the stop of the blower are stored in advance.

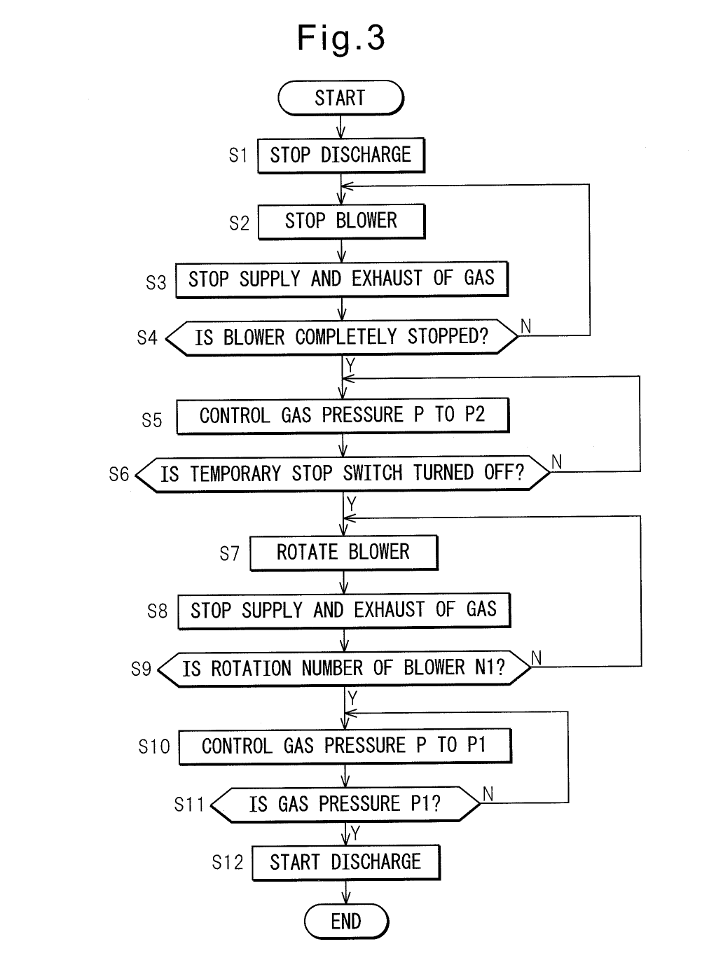

FIG. 3 is a flowchart illustrating an example of processes carried out in control section 70, in particular, a temporary stop process. The operation illustrated in this flowchart is started, for example, when temporary stop switch 75 is turned on or, in other words, when the temporary stop instruction is input in the laser oscillation state. Before temporary stop switch 75 is turned on, blower 30 rotates at the predetermined rotation number N1 as a result of the process in blower control section 72. The gas pressure P is maintained at the predetermined gas pressure P1 as a result of the process in pressure control section 73. The electric power is supplied to discharge tube 23 as a result of the process in power control section 71 so that laser oscillator 20 oscillates the laser light. Further, exhaust device 62 rotates at a predetermined rotation number N10 as a result of the process in exhaust control section 74.

In step S1, a control signal is output to laser power supply 24 to stop the discharge operation from discharge tube 23. As a result, the laser output from laser oscillator 20 is stopped.

In step S2, a control signal is output to the blower inverter to stop the rotation of blower 30. As a result, the flow of the laser gas along gas passage 101 is stopped.

In step S3, control signals are output to supply device 51 and exhaust valve 61 to close them. On the other hand, a control signal is output to exhaust inverter 63 to temporarily stop the rotation of exhaust device 62. This process takes into consideration that blower 30 does not stop immediately after the temporary stop instruction but first decelerates and then stops and, consequently, the gas pressure P in vessel 10 is not stable before blower 30 completely stops. The supply and exhaust of the laser gas is stopped till blower 30 is completely stopped.

In this example, the rotation of blower 30 is completely stopped after the temporary stop instruction. However, the rotation of blower 30 may not be completely stopped but it may be reduced to a predetermined rotation number N2. More specifically, in step S2, the rotation number of blower 30 may be reduced to the predetermined rotation number N2 and, then, in step S3, the supply and exhaust of the laser gas may be stopped. The predetermined rotation number N2 is a value less than the predetermined rotation number N1. Instead of reducing to the predetermined rotation number N2, the rotation number of blower 30 may be reduced by a predetermined rotation number ΔN.

In step S4, it is determined whether the stop operation of blower 30 is completed or not or, in other words, whether the rotation of blower 30 is completely stopped or not. This process is carried out, for example, by determining whether the predetermined deceleration time has elapsed after the stop instruction of blower 30 or not, or by monitoring the output from the blower inverter. If a negative decision is made in step S4, the process returns to step S2. If an affirmative decision is made in step S4, the process proceeds to step S5.

In step S5, the signals from pressure gauge 33 are read. The opening and closing of supply device 51 and the exhaust valve 61 is controlled so that the gas pressure detected by pressure gauge 33 is equal to the predetermined gas pressure P2 at the stop of the blower. Further, the rotation number of exhaust device 62 is controlled to a predetermined rotation number N11. As a result, the laser gas in laser gas vessel 10 is replaced and, for example, even when the atmosphere penetrates into laser gas vessel 10, the gas pressure P is maintained at the predetermined gas pressure P2. In this case, since the laser oscillation is stopped, gas decomposition due to the laser oscillation does not occur. Further, since the gas temperature is lower than that during the laser oscillation, molecular emission from the inner wall of the laser gas vessel is low. As a result, if the amount of the replaced laser gas in laser gas vessel 10 is small, then as a consequence, exhaust device 62 does not have to have large exhaust capacity. As a result, the predetermined rotation number N11 is set at a value lower than the rotation number N10 of exhaust device 62 during the laser oscillation.

In step S6, it is determined whether temporary stop switch 75 is turned off or not or, whether the temporary stop cancellation instruction is input or not. If a negative decision is made in step S6, the process returns to step S5. If an affirmative decision is made in step S6, the process proceeds to step S7.

In step S7, a control signal is output to the blower inverter to rotate blower 30 at the predetermined rotation number N1. As a result, the laser gas circulates along gas passage 101.

In step S8, control signals are output to supply device 51 and exhaust valve 61 to close them and, on the other hand, a control signal is output to exhaust inverter 63 to temporarily stop the rotation of exhaust device 62. More specifically, since the gas pressure P is not stable till the rotation number of blower 30 reaches the predetermined rotation number N1, supply device 51 and exhaust valve 61 are closed to stop the supply of the laser gas to vessel 10 and exhaust of the laser gas from vessel 10.

In step S9, it is determined whether the rotation number of blower 30 has reached the predetermined rotation number N1 or not. This process is carried out, for example, by determining whether a predetermined acceleration time has elapsed after the stop cancellation instruction of blower 30 or not or, by monitoring the output from the blower inverter.

In step S10, the signal from pressure gauge 33 is read, and the opening and closing of the supply device 51 and exhaust valve 61 is controlled so that the gas pressure P detected by pressure gauge 33 is equal to the predetermined gas pressure P1. Further, the rotation number of exhaust device 62 is controlled to be the predetermined rotation number N10.

In step S11, it is determined whether the gas pressure P detected by pressure gauge 33 is equal to the predetermined gas pressure P1 or not. If an affirmative decision is made in step S11, the process proceeds to step S12. If a negative decision is made in step S11, the process returns to step S10.

In step S12, a control signal is output to laser power supply 24 to restart the discharge from discharge tube 23. As a result, stable laser light can be output from laser oscillator 20 at the predetermined gas pressure P1. After that, the temporary stop process terminates.

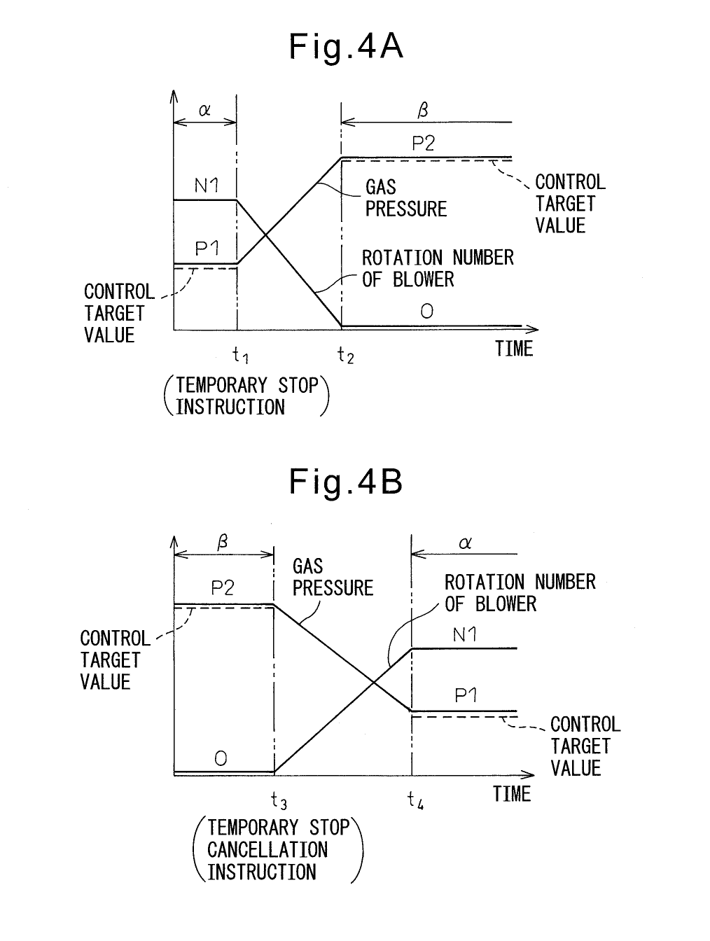

The operations of gas laser device 100 according to this embodiment will be described more specifically. FIGS. 4A and 4B are diagrams illustrating variations of the number of rotations of the blower and the gas pressure P in laser gas vessel 10 after the temporary stop instruction and after the temporary stop cancellation instruction of the laser oscillation, respectively. In the figures, control target values of the gas pressure P (dotted lines) are also illustrated.

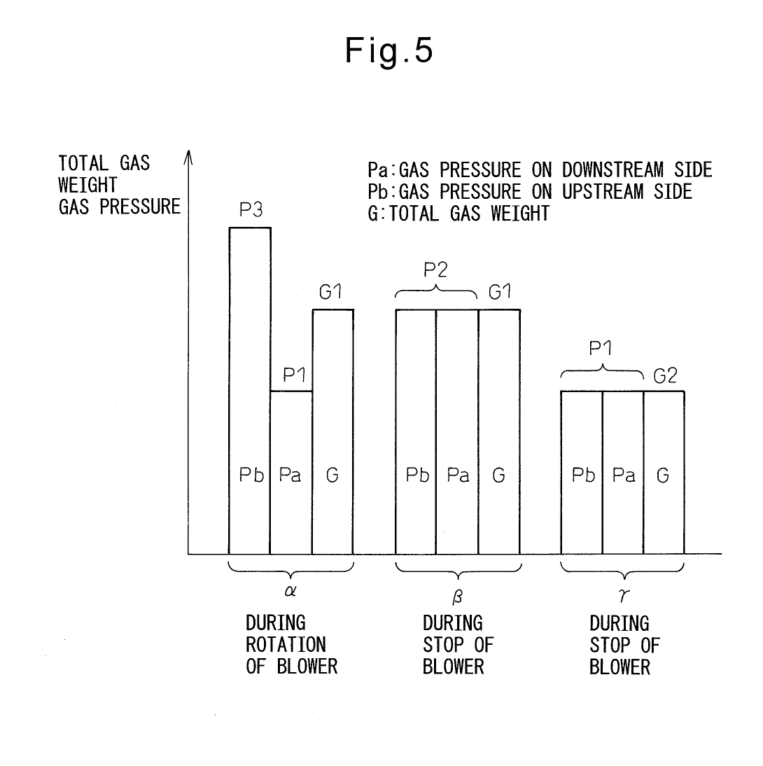

Before the temporary stop instruction of the laser oscillation, as illustrated in FIG. 4A, blower 30 rotates at the predetermined rotation number N1 and the gas pressure P is controlled to the predetermined gas pressure P1 that is the control target value. At this time, a gas state in vessel 10 is represented as a in FIG. 5. In FIG. 5, Pa is a gas pressure on the upstream side of blower 30 or, in other words, a gas pressure detected by pressure gauge 33. Pb is a gas pressure on the downstream side of blower 30 (or between blower 30 and second heat exchanger 32). G is a total gas weight in the vessel. When blower 30 rotates at the predetermined rotation number N1, the gas pressure Pa on the upstream side of the blower is the predetermined gas pressure P1 illustrated in the state α, and the gas pressure Pb on the downstream side of the blower is P3 (>P1). At this time, a total gas weight in vessel 10 is G1.

At time t1 in FIG. 4A, once temporary stop switch 75 is turned on, the output of the laser light from laser oscillator 20 is stopped and, further, blower 30 starts the stop operation (step S1, step S2). As a result, wasteful electric power consumption of gas laser device 100 can be suppressed, and power saving effect can be obtained. After temporary stop switch 75 is turned on, the rotation number of the blower is reduced and, as a result, the gas pressure Pa on the upstream side of the blower is increased. Until blower 30 completely stops (time t1 to time t2), the pressure adjustment by the supply and exhaust of the laser gas is not carried out (step S3).

At time t2, once the rotation of blower 30 is completely stopped, the pressure adjustment by the supply and exhaust of the laser gas is started, and the gas pressure Pa on the upstream side of the blower is controlled to the predetermined gas pressure P2 (step S5). At this time, exhaust device 62 rotates at the rotation number N11 less than that before the stop of the laser oscillation (<N10), so that power consumption can be further suppressed. The gas state at the temporary stop is represented as β in FIG. 5, and the gas pressures Pa and Pb on the upstream and downstream sides of the blower become equal to each other, respectively. In this case, the gas pressure P in vessel 10 is the value P2 corresponding to the predetermined gas pressure P1 when the blower rotates or, in other words, a value determined by correlation between the rotation number of the blower and the gas pressure P when it is assumed that the total gas weight is not changed. The total gas weight is still G1.

After that, at time t3 in FIG. 4B, once temporary stop switch 75 is turned off, blower 30 starts the rotation operation (step S7). At this time, as the rotation number of blower 30 increases, the gas pressure Pa on the upstream side of the blower increases. However, until the rotation number of the blower reaches the predetermined rotation number N1 (time t3 to time t4), the pressure adjustment by the supply and exhaust of the laser gas is not carried out (step S8).

At time t4, once the rotation number of the blower reaches the predetermined rotation number N1, the pressure adjustment by the supply and exhaust of the laser gas is started so that the gas pressure Pa on the upstream side of the blower is controlled to the predetermined gas pressure P1 (step S10). In this state, discharge tube 23 starts the discharge, and laser oscillator 20 outputs the laser light (step S12). At this time, the gas state in laser gas vessel 10 is α in FIG. 5. In this case, since the gas pressure in vessel 10 is controlled to P2 at the stop of the rotation of the blower, the gas pressure in vessel 10 becomes P1 only by increasing the rotation number of the blower to the predetermined rotation number N1. Consequently, in a short time after temporary stop switch 75 is turned off, the discharge of discharge tube 23 can be started, and working efficiency in the laser processing and the like can be improved.

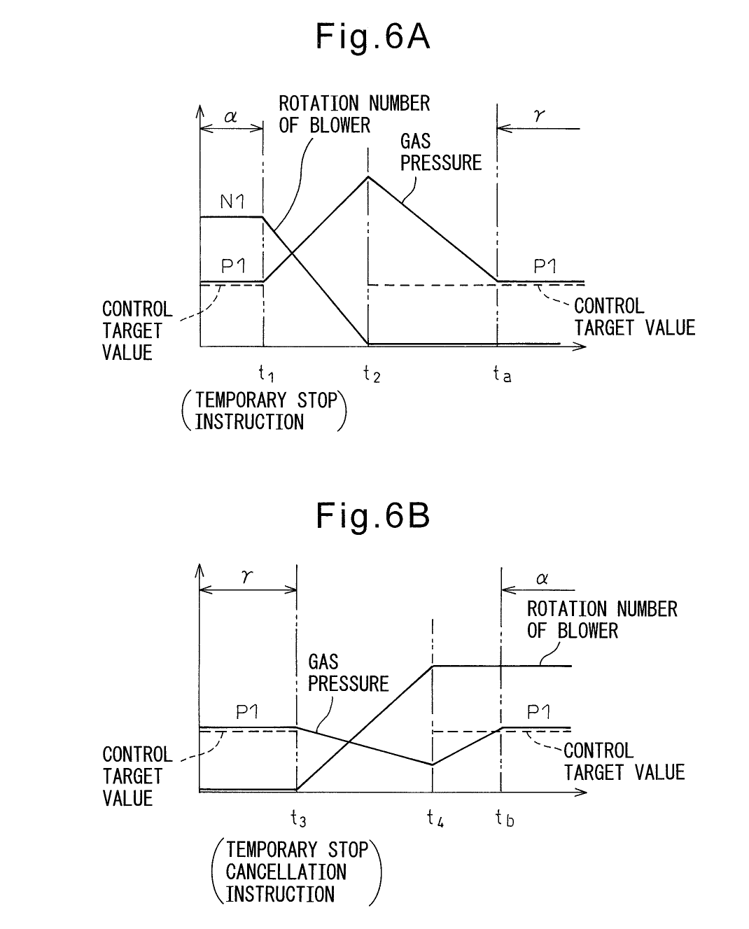

In contrast to this, when the gas pressure at the stop of the rotation of the blower is controlled to a value other than P2, it is difficult to start the discharge in a short time after temporary stop switch 75 is turned off. This issue will be described as follows. FIGS. 6A and 6B are diagrams illustrating an example of variations of the rotation number of the blower and the gas pressure P when the gas pressure at the stop of the rotation of the blower is set to P1, respectively. In this case, as illustrated in FIG. 6A, the laser gas has to be exhausted from laser gas vessel 10 during time t2 to time ta so that the gas pressure is reduced from P2 to P1 after the stop of the rotation of blower 30 in response to the turning on of temporary stop switch 75. As a result, after time ta, the gas state in vessel 10 becomes γ in FIG. 5, wherein the total gas weight becomes G2 that is less than the total gas weight G1 before the temporary stop.

After that, as illustrated in FIG. 6B, at time t3, once temporary stop switch 75 is turned off, as the rotation number of the blower increases, the gas pressure Pa is reduced, so that at time t4, the gas pressure Pa is less than the predetermined gas pressure P1. As a result, in order to start the laser oscillation, the laser gas has to be supplied to the vessel via supply device 51 so that the gas pressure Pa is equal to the predetermined gas pressure P1. At time tb, once the gas pressure Pa reaches the predetermined gas pressure P1, the laser oscillation can be possible. However, it takes more time than the case of FIG. 4B to reach the state in which the laser oscillation can be possible. Further, the amount of exchange of the laser gas in vessel 10 is extremely wasteful.

According to this embodiment, the following effects can be exhibited.

(1) In response to the turning on of temporary stop switch 75, not only the output of the laser light but also the rotation of blower 30 is stopped. As a result, the power consumption of gas laser device 100 can be suppressed.

(2) The gas pressure P in laser gas vessel 10 at the stop of the rotation of the blower is controlled to the predetermined gas pressure P2 corresponding to the predetermined gas pressure P1 at the time of the rotation of the blower. As a result, after instructing the temporary stop cancellation of the laser oscillation, the gas pressure P in laser gas vessel 10 can be returned to the predetermined gas pressure P1 in a short time, and the operations such as the laser processing can be carried out efficiently.

(3) After the temporary stop instruction, even when the rotation of blower 30 is not stopped and the rotation number of blower 30 is reduced, the power consumption of gas laser device 100 can be suppressed similarly. In addition, after the temporary stop cancellation instruction, the gas pressure P can be returned to the predetermined gas pressure P1 in a more shorter time.

(4) Until blower 30 stops completely and the gas pressure P becomes stable, the gas pressure P in vessel 10 is not adjusted. As a result, the more than necessary supply and exhaust of the laser gas can be avoided.

(5) At the time of the stop of the rotation of the blower, the rotation number of exhaust device 62 is reduced. As a result, the power consumption can be further suppressed.

(6) Exhaust device 62 is provided in exhaust passage 60 and, further, exhaust valve 61 that can change the aperture area of exhaust passage 60 is provided in series with respect to exhaust device 62. As a result, the gas pressure P in vessel 10 can be adjusted accurately.

Though blower 30 is cooled by cooling device 40 in the embodiment described above, other components of the gas laser device can be cooled. In this case, the cooling ability may be changed in response to the on and off of temporary stop switch 75. For example, control section 70 may control coolant circulation device 42 so that the amount of circulation of the coolant after the temporary stop instruction becomes less than that before the temporary stop instruction.

Though the gas passage through which the laser gas circulates is formed by laser gas vessel 10 in the embodiment described above, the configuration of the passage formation section is not limited to that described above. Though pressure gauge 33 is provided on the upstream side of blower 30, the pressure detection section may be provided in another point (for example, on the downstream of blower 30) so long as the gas pressure P changing according to the rotation number of blower 30 is detected. Though the temporary stop of oscillation of the laser light is instructed by the operation of temporary stop switch 75, another instruction section may be used.

Though supply device 51 is provided in supply passage 50 and exhaust valve 61 and exhaust device 62 are provided in exhaust passage 60, the configuration of the gas supply and exhaust section for supplying the laser gas to gas passage 101 and exhausting the laser gas from gas passage 101 is not limited to that described above. Though exhaust device 62 is configured by the exhaust fan so that the rotation number of the fan is reduced when the temporary stop is instructed, exhaust device 62 may be configured differently so that the exhaust ability may be reduced when the temporary stop is instructed. The rotation number of exhaust device 62 before the temporary stop instruction may be equal to that after the temporary stop instruction.

Control section 70 controls the rotation of blower 30 and the supply and exhaust of the gas in the embodiment described above. However, as long as blower 30 is rotated at the predetermined rotation number N1 and the supply and exhaust of the gas is controlled so that the gas pressure P detected by pressure gauge 33 is the predetermined gas pressure P1 (a first target gas pressure) before the temporary stop instruction and, upon the temporary stop instruction, the rotation number of blower 30 is reduced or the rotation is stopped and the supply and exhaust of the gas is controlled so that the gas pressure P detected by pressure gauge 33 is the predetermined gas pressure P2 (a second target gas pressure) corresponding to the predetermined gas pressure P1 during the rotation of the blower, the process in control section 70 is not limited to that described above.

According to the present invention, upon the temporary stop instruction, the number of rotations of the blower is reduced or the rotation is stopped and the supply and exhaust of the gas is controlled so that the gas pressure in the gas passage is the second target gas pressure corresponding to the first target gas pressure during the rotation of the blower. As a result, power consumption can be suppressed and, after canceling the temporary stop instruction, it is possible to return to the state in which the laser can be oscillated in a short time.

While the present invention has been described with reference to the preferred embodiments thereof, it will be understood, by those skilled in the art, that various modifications and changes may be made thereto without departing from the scope of the appended claims.

1. A gas laser device comprising:
a passage formation section forming a gas passage through which a laser gas circulates;
a blower circulating the laser gas along the gas passage;
a laser oscillator oscillating laser light by using the laser gas flowing through the gas passage as an excitation medium;
a laser power supply supplying electric power for exciting the laser gas to the laser oscillator;
a pressure detection section detecting a gas pressure of the laser gas in the gas passage which changes depending on a rotation number of the blower;
a gas supply and exhaust section supplying the laser gas to the gas passage and exhausting the laser gas from the gas passage;
an instruction section instructing a temporary stop of oscillation of the laser light by the laser oscillator; and
a control section controlling the blower and the gas supply and exhaust section in response to an instruction from the instruction section,
wherein, before the instruction section instructs the temporary stop, the control section controls the blower so as to rotate at a predetermined rotation number, and controls the gas supply and exhaust section so that the gas pressure detected by the pressure detection section is a first target gas pressure and,
once the instruction section instructs the temporary stop, the control section controls the blower so as to reduce the rotation number of the blower or stop the rotation of the blower, and controls the gas supply and exhaust section so that the gas pressure detected by the pressure detection section is a second target gas pressure corresponding to the first target gas pressure during the rotation of the blower.

2. The gas laser device according to claim 1, wherein, once the instruction section instructs the temporary stop, the control section controls the blower so as to reduce the rotation number of the blower or stop the rotation of the blower and, after the rotation number of the blower is reduced or the rotation of the blower is stopped, controls the gas supply and exhaust section so that the gas pressure detected by the pressure detection section is the second target gas pressure.

3. The gas laser device according to claim 1, wherein the gas supply and exhaust section comprises:
an exhaust device exhausting the laser gas from the gas passage; and
a supply device supplying the laser gas to the gas passage.

4. The gas laser device according to claim 3, wherein the exhaust device has an exhaust fan for aspirating the laser gas from the gas passage, and
wherein, once the instruction section instructs the temporary stop, the control section makes an exhaust ability of the exhaust fan lower than the exhaust ability of before the temporary stop is instructed.

5. The gas laser device according to claim 3, wherein the exhaust device is disposed in an exhaust passage communicating with the gas passage, and
wherein the gas supply and exhaust section further comprises a valve device changing an aperture area of the exhaust passage.

6. The gas laser device according to claim 1, further comprising a cooling device for cooling a predetermined component by circulating coolant,
wherein, once the instruction section instructs the temporary stop, the control section further controls the cooling device so that an amount of circulation of the coolant becomes less than the amount of circulation before the temporary stop is instructed.
